(19) United States
(12) Patent Application Publication
(10) Pub. No.: US 2026/0244503 A1
(43) Pub. Date: Aug. 20, 2026

(54) DYNAMIC SCHEDULER FOR MACHINE LEARNING MODEL INFERENCES ON A HETEROGENEOUS COMPUTING SYSTEM

(71) Applicant: Advanced Micro Devices, Inc., Santa Clara, CA (US)

(72) Inventor: Jipeng LI, Shanghai (CN)

(21) Appl. No.: 19/199,152

(22) Filed: May 5, 2025

(30) Foreign Application Priority Data
Feb. 17, 2025 (WO) PCT/CN2025/077644

(51) Int. Cl. G06F 9/50

(52) U.S. Cl. CPC G06F 9/5027

(57) ABSTRACT

Embodiments herein relate to implementing a dynamic scheduler within a heterogeneous computing system. At runtime, there may be various circumstances the computing system is faced with that makes the usage of one type of processor more optimum than another processor for a certain number or type of calculations. When presented with an inference task, at runtime, a dynamic scheduler can determine one set of calculations that should be made on one processor, and another set of calculations that should be made on another, different processor. The separate calculations can then be combined to produce the result for the inference task.

### TECHNICAL FIELD

The following relates to machine learning inference tasks on heterogeneous computing systems.

### BACKGROUND

Heterogeneous computing systems integrate multiple types of processors. The types of processors can include but are not limited to central processing units (CPUs), neural processing units (NPUs), and graphics processing units (GPUs). Heterogeneous systems can take advantage of the strengths of these different processor types, and because of this, heterogeneous computing is popular in technical fields that involve high computing power, such as gaming, artificial intelligence, etc.

### SUMMARY

According to some embodiments, a method is described that includes receiving, at a heterogeneous computing system, an inference task associated with a machine learning (ML) model, scheduling a first set of calculations to be made at a first type of processor of the heterogeneous computing system based on compute resources for the execution of the inference task on the first type of processor that are determined at runtime, scheduling a second set of calculations to be made at a second type of processor of the heterogeneous computing system based on compute resources for the execution of the inference task on the second type of processor that are determined at runtime, and combining the first set of calculations made on the first type of processor with the second set of calculations made on the second type of processor.

According to other embodiments, a system executable by one or more computer processors to perform operations is disclosed. The operations include receiving, at a heterogeneous computing system, an inference task associated with a machine learning (ML) model, scheduling a first set of calculations to be made at a first type of processor of the heterogeneous computing system based on compute resources for the execution of the inference task on the first type of processor that are determined at runtime, scheduling a second set of calculations to be made at a second type of processor of the heterogeneous computing system based on compute resources for the execution of the inference task on the second type of processor that are determined at runtime, and combining the first set of calculations made on the first type of processor with the second set of calculations made on the second type of processor.

According to other embodiments, a computer-readable storage medium having computer-readable program code embodied therewith, the computer-readable program code executable by one or more computer processors to perform operations, the operations including: receiving, at a heterogeneous computing system, an inference task associated with a machine learning (ML) model, scheduling a first set of calculations to be made at a first type of processor of the heterogeneous computing system based on compute resources for the execution of the inference task on the first type of processor that are determined at runtime, scheduling a second set of calculations to be made at a second type of processor of the heterogeneous computing system based on compute resources for the execution of the inference task on the second type of processor that are determined at runtime, and combining the first set of calculations made on the first type of processor with the second set of calculations made on the second type of processor.

### BRIEF DESCRIPTION OF DRAWINGS

FIG. 1 illustrates a heterogeneous computing system with a dynamic scheduler, according to some embodiments.

FIG. 2 illustrates a dynamic scheduler according to some embodiments.

FIG. 3 illustrates a flow diagram of the dynamic scheduler within the computing system, according to some embodiments.

FIG. 4 illustrates a flow diagram for a static scheduler, according to some embodiments.

FIG. 5 illustrates a flow diagram for implementing the static scheduler with the dynamic scheduler, according to some embodiments.

### DETAILED DESCRIPTION

Embodiments herein relate to implementing a dynamic scheduler within a heterogeneous computing system. A heterogeneous computing system can be used for inference tasks facilitated via an ML (machine learning) model. At runtime, there may be various circumstances the computing system is faced with that makes the usage of one type of processor more optimum than another processor for a certain number or type of calculations. When presented with an inference task, at runtime, a dynamic scheduler can determine one set of calculations that should be made on one processor, and another set of calculations that should be made on another, different processor. The separate calculations can then be combined to produce the result for the inference task. Scheduling these calculations by the dynamic scheduler offers improvements in efficiency, power consumption and usage, and memory usage of the heterogeneous computing system.

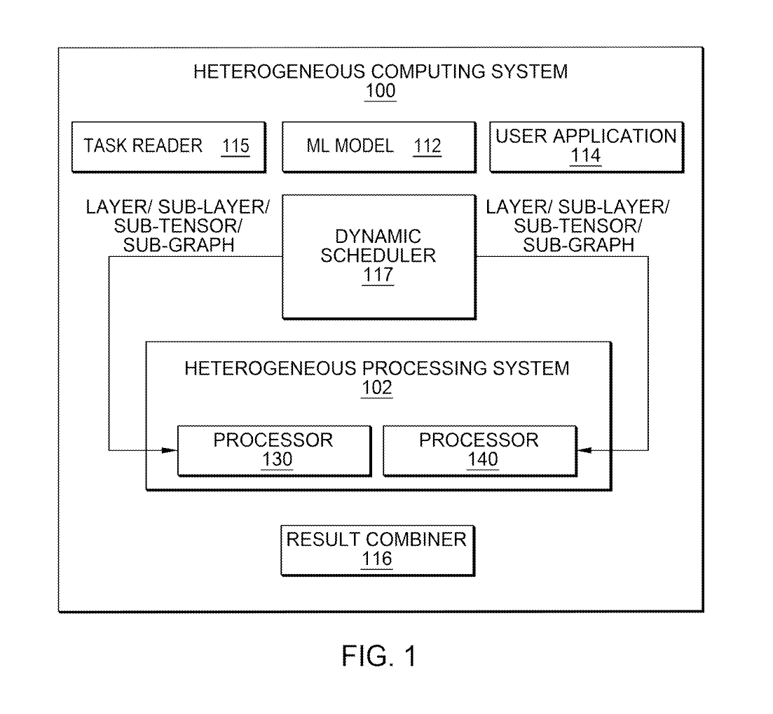

FIG. 1 illustrates a heterogeneous computing system with a dynamic scheduler, according to some embodiments. The dynamic scheduler 117 is implemented on a heterogeneous computing system 100. In one embodiment, the dynamic scheduler 117 is a software component that is part of a large language model (LLM) application executing on the computing system 102, such as executing on a processor in the processing system 102 or a separate processor. Within the heterogeneous computing system 100 is a heterogeneous processing system 102 containing a processor 130 and a processor 140. The dynamic scheduler 117 analyzes an inference task read by the task reader 115, analyzes the ML model 112, the user application implemented 114 alongside the ML model 112, as well, as components such as weights, power usage, and compute power, etc. to determine a set of calculations that should be allocated to the processor 130, and another set of calculations that should be distributed to the processor 140. The processor 130 and the processor 140 independently make their allocated calculations, and the results of those calculations are sent to the result combiner 116, which outputs a complete calculation that goes toward the inference task. The results combiner 116 may be a software component that is part of a LLM application executing on the computing system 102, such as executing on a processor in the processing system 102 or a separate processor.

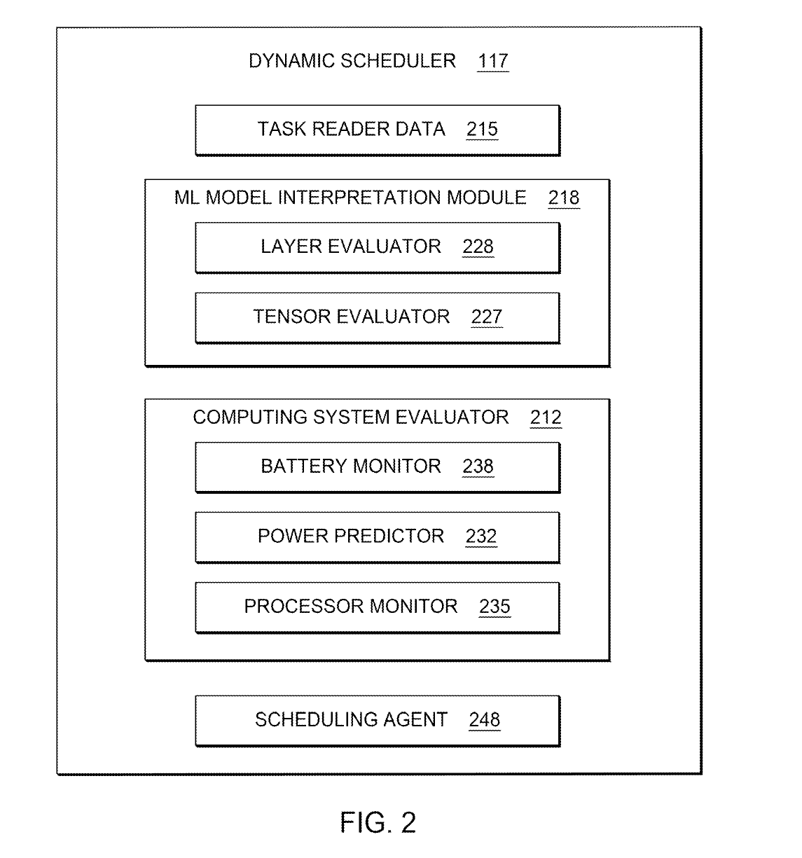

More details on the dynamic scheduler 117 will be discussed below in FIG. 2.

The task reader 115 reads an inference task for the ML model 112 to perform. An inference task can include instructing the ML model 112 to perform an inference or make a decision using unseen data. The process can involve the ML model 112 using learned patterns from training to the input, enabling the completion of tasks such as image classification, speech recognition, etc.

The ML model 112 can use or interact with the user application 114. An example of the user application 114 can be an external application to fine tune the responses or capabilities of the specialized and trained ML model 112. For example, the ML model 112 may use an external generative artificial intelligence (AI) source to generate a natural language response communicating the results of the inference task calculated by the ML model 112.

The dynamic scheduler 117 considers the task, receiving information from the task reader 115, the ML model 112 being used, and the user application 114. From the ML model 112, it can determine the model type, and dissect even further, the internal equations and layers that make up the model 112. For example, some large language models (LLMs) use layers and tensors to process and generate text for inference tasks. An LLM can be a deep neural network made of many layers of transformer blocks. The layers of an LLM can have components such as self-attention modules and feed forward networks to help the model detect relationships between words, and recognize patterns to help it generate text. During the inference phase, an input (such as a sentence prompt) can be converted into tensors, or numerical representations, which go through the layers of the LLM and are used to make calculations to refine the LLM's understanding of the prompt.

Tensors can be multidimensional arrays and they can store numerical data representing words, embeddings, and the computations made within the ML model 112. The layers of the ML model 112 can refine the tensor computations by applying learned weights, nonlinear transformations, and normalization techniques. .

The dynamic scheduler 117 receives information from the heterogeneous computing system 100. The dynamic scheduler 117 can query the heterogeneous computing system 100 to receive the current available compute cycles and memory usage. The dynamic scheduler 117 assesses the computational power available and current power usage in the heterogeneous computing system 100, and assesses the computational power the ML model 112 may use to execute the inference task. The computational power available in the heterogeneous computing system 100 can be affected by the current battery life available, the power consumption (whether or not it is being charged), the memory available, the availability of the processor 130, and the availability of the processor 140, among other things. The dynamic scheduler 17 assesses the available computational power and considers the computations that the ML model 112 should make to complete the inference task, in conjunction with the processing power that should be used by the task reader 115 and the user application 114. Once these assessments are made, the dynamic scheduler 117 can determine a set of computations that should be completed by one processor of the heterogeneous computing system based on compute resources, such as the processor 130, and a second, different set of computations that should be completed by another processor of the heterogeneous computing system, such as the processor 140, based on compute resources. The dynamic scheduler 117 is discussed in more detail with FIG. 2.

While FIG. 1 illustrates two processors 130 and 140 (e.g., a GPU and NPU) in some embodiments, there are more than two processors (e.g., a GPU, NPU, and a CPU, or multiple NPUs and multiple GPUs), in which case the dynamic scheduler can schedule calculations across the number of available processors.

Once the first set and second set of computations are complete, their results can be combined in the result combiner 116 for a completed computed result for the ML model 112.

The sets of computations determined by the dynamic scheduler can include a set of whole layers, where some layers are sent to one processor for computing, and another set of whole layers are sent to another processor for computing. The set of computations can also include sub layers, or sub graphs, or certain tensors of the same layer to be computed at one processor, and other certain tensors of the same layer to be computed at a different processor. The set of computations can also include sub- tensors, or splitting the same tensor such that certain calculations pertaining to one part of one tensor are handled by one processor, and the remaining calculations pertaining to the remaining part of the tensor are handled by another processor. The set of computations can be split in various ways.

FIG. 2 illustrates the dynamic scheduler 117. As mentioned in FIG. 1, the dynamic scheduler 117 considers the consumption power available, and the consumption power that should be used for the completion of an inference task by the ML model 112.

The dynamic scheduler 117 receives task reader data 215, indicating the task that the ML model 112 is instructed to perform. The dynamic scheduler 117 also contains an ML model interpretation module 118 to interpret the ways in which the ML model 112 will perform the inference task. For example, an LLM may use multiple layers with tensors to perform calculations (as mentioned above) but a linear model may use intermediate functions without layers and tensors. The ML model interpretation module 118 evaluates the components of the ML model 112, such as layers of the ML model, using a layer evaluator 228, and evaluates the tensors of the layers using a tensor evaluator 227.

The dynamic scheduler 117 uses a computing system evaluator 212 to monitor the available computing power on the heterogeneous computing system 100. The computing system evaluator 212 contains a battery monitor 238, a power predictor 232, and a processor monitor 235.

The scheduling agent 248 determines the set of tasks allocated to the different processors of the heterogeneous computing system 100 using the information from the ML model interpretation module 218, and the computing system evaluator 212.

The layer evaluator 228 can identify the layers of the ML model 112 by understanding the ML model's 112 architecture and how the different layers of the ML model 112 can contribute to performing the inference task, provided to the dynamic scheduler as the task reader data 215. The layers of the neural network can serve different roles. For example, some layers extract features, other layers refine information, and other layers generate predictions, among other things. The layer evaluator 228 can identify the function of the layers by analyzing the ML model's 112 architecture. The layer evaluator 228 can implement neural network visualizing technology. The layer evaluator 228 can inspect layer types, shapes of input/output tensors, and weight distributions to find information on how the different layers contribute to the inference task. Techniques such as layer-wise activation visualization or feature important analysis can help reveal the function of certain layers and their impact on model decisions.

The tensor evaluator 227 identifies the tensors of the layers of the ML model 112. The tensor evaluator 227 can analyze the way the data flows through the ML model 112 to understand the shape and type of tensor at the different layers. As mentioned above, tensors can be multidimensional arrays that store numerical representations of inputs, computations and outputs. Techniques such as forward passes with simple inputs, or tensor inspection functions, among other things, can be implemented by the tensor evaluator 227 to evaluate the computational power that should be given to execute the computations for the tensors at the different layers of the ML model.

The battery monitor 238 can monitor the power provided to the heterogeneous computing system 100. The battery monitor 238 can determine whether or not the battery is plugged into a power source, how much energy is being used by the battery in the current state of the heterogeneous computing system, etc. The battery monitor can also determine which components of the computing system use the most power.

The power predictor 232 predicts the amount of power that will be used to perform the inference task. The power predictor 232 can take information from the layer evaluator 228 and the tensor evaluator 227, as well as the current state of power of the heterogeneous computing system 100, to predict the amount of power that will be used to perform the inference task.

The processor monitor 235 determines the amount of memory, or capabilities, the processors of the heterogeneous computing system 100 can support. The processor monitor 235 can look at available memory, computing power, type of computational tasks the processor may be specialized for, etc.

The scheduling agent 248 considers the factors from the ML model interpretation module 218, and the computing system evaluator 212 to schedule, at runtime, which set of calculations will go to which processor of the heterogeneous computing system 100.

For example, the dynamic scheduler can probe the system status in the prefill and decode stages of in LLM execution. The prefilling stage uses more computing power than the decode stage. As such, before executing the prefilling stage, the dynamic scheduler determines the utilization of, e.g., the NPU and GPU to determine the one with the most available computing power.

On the other hand, the decode stage relies more on memory bandwidth so before performing that stage the dynamic scheduler can probe the bandwidth of the selected processor (e.g., the NPU or the GPU) several times when performing the decoding stage to prevent accidentally running out of memory bandwidth because of background task. For instance, assuming the decode stage is being performed on the NPU, at the middle of the decode stage, the dynamic schedule can probe whether the NPU memory bandwidth is decreasing and whether the operator type is also suitable for GPU. If so, the dynamic scheduler can change the process to running on the GPU to maintain the availability of the LLM application.

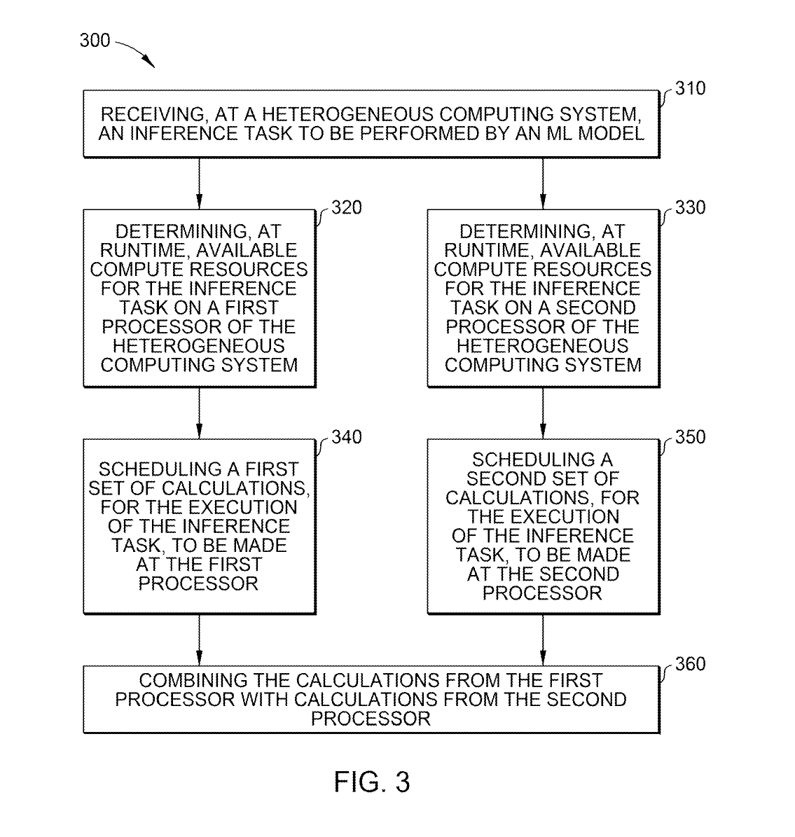

FIG. 3 illustrates a flow diagram for scheduling calculations for the different processors of the heterogeneous computing system 100 at runtime.

At block 310 the heterogeneous computing system receives an inference task to be performed by the ML model 112.

As mentioned, the inference task can refer to various prediction or decision tasks for the ML model 112 to perform. For example, in image recognition, an inference task can involve identifying objects in a photo, in an LLM, it can involve recommending a movie to a user, and much more.

At block 320, at runtime, the dynamic scheduler 117 determines available compute resources for the inference task on a first processor 130 of the heterogeneous computing system 100.

At block 330, similarly, the dynamic scheduler 117 determines available compute resources for the inference task on a second processor 140 of the heterogeneous computing system 100.

As mentioned in FIG. 2, the dynamic scheduler 117 analyzes the ML model 112 using an ML model interpretation module 118. Additionally, at runtime, the dynamic scheduler 117 uses the computing system evaluator 212 to evaluate the current power level and battery state of the heterogeneous computing system 100, the memory and computing power available at the plurality of processors used by the system, and a prediction of how much compute power the inference task will use.

At block 340 the dynamic scheduler 117 uses its analysis to schedule a first set of calculations, for the execution of the inference task, to be made at the first processor 130. Similarly, at block 340, the dynamic scheduler 117 schedules a second set of calculations, for the execution of the inference task, to be made at the second processor 140.

As discussed in FIG. 1, the first set of calculations and the second set of calculations can be a set of layers, a set of sub layers (or tensors in some cases), a set of different parts of tensors, among other things. The first set of calculations and the second set of calculations can depend on the type of ML model 112. As discussed in FIG. 2, the dynamic scheduler 117 considers the compute power available at the processors of the heterogeneous computing system 100, as well as the compute power that the ML system 112 may use to perform the inference task, the battery level of the heterogeneous computing system, and other things, to determine the sets of calculations, and the processors where the sets of calculations should be sent.

At block 360 the result combiner 116 combines the calculations from one of the processors, such as the processor 130, with another processor, such as the processor 140, to generate a completed calculation. The results from however many processors are used can be combined by the result combiner 116.

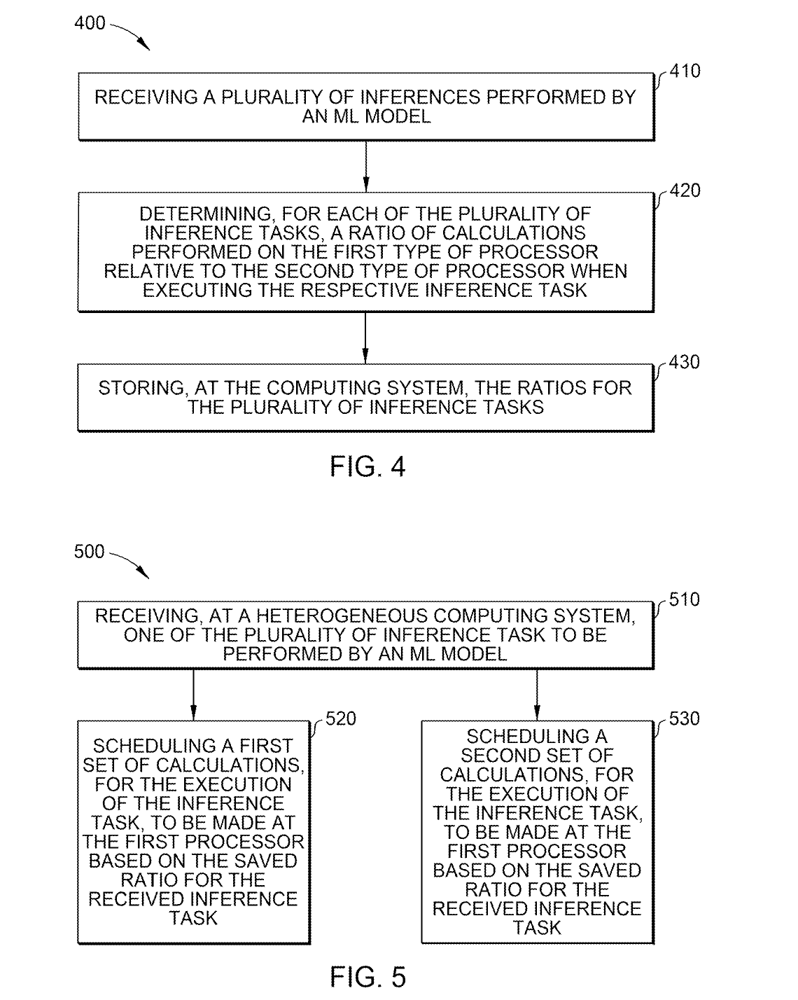

FIG. 4 illustrates the heterogeneous computing system generating a file that contains pre-determined data of inference tasks the ML model 112 can perform, and which processors of the heterogeneous computing system 100 can perform certain calculations more efficiently than others. The file generated by the computing system can be done at compile time, rather than runtime, and can be used by the dynamic scheduler 117 at runtime to ease the computational load of the scheduling agent 248. Using the file, generated at compile time, by the scheduling agent 248 can help guide scheduling the calculations to be sent to the various processors.

At block 410, at compile time, the ML model 112 receives a plurality of inference tasks the model can perform. As mentioned, potential inference tasks depend on the model's architecture and capacities.

At block 420, a machine readable file of various formats can be generated with a determined a ratio of calculations optimally performed on the first type of processor relative to the second type of processor when executing a respective inference task. For example, a ML model asked to perform the inference task of generating an image of a word may have the majority of calculations determined to be optimum if they are performed at the GPU of a computing system, as a GPU can more optimally perform calculations involving the generation of an image.

The file can be generated by the heterogeneous computing system 100 at compile time. As mentioned at block 410, the heterogeneous computing system 100 can interpret the ML model 112, and determine various inference tasks it is capable of completing. After analyzing each of the tasks and the computational demand for each of the plurality of tasks, a scheduling target, or ratio for calculations to be performed at each of the plurality of processors can be determined. As mentioned, the scheduling agent can use the predetermined scheduling target, or ratios determined in the file at compile time, during runtime.

At block 430 the ratios for the plurality of inference tasks is stored on the heterogeneous computing system 100. The file can take various formats, or can simply be stored as metadata.

FIG. 5 illustrates a flow diagram showing how the dynamic scheduler can use the predetermined file to help schedule inference tasks. At block receiving, at a heterogeneous computing system 100 receives, one of the plurality of inference task to be performed by an ML model 112. This process is similar to the block 310 of FIG. 3.

At block 520, similar to what is discussed in FIG. 3, the dynamic scheduler 117 schedules a first set of calculations, for the execution of the inference task, to be made at the first processor based on the saved ratio for the received inference task.

Similarly, at block 530, the dynamic scheduler 117 scheduling a first set of calculations, for the execution of the inference task, to be made at the first processor.

However, at both blocks 520 and 530, the dynamic scheduler 117 considers the saved ratio discussed in FIG. 4, pertaining to the received inference task from block 510. In one embodiment, the saved is used as a guideline when assigning tasks between two processors (e.g., one processor should get 25% of the workloads while the other gets 75%). Using the ratio, which can be part of the task reader data 215, allows the dynamic scheduler 117 to be more efficient, as its workload is lessoned with the saved ratios.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a "circuit," "module" or "system." Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A method comprising:
receiving, at a heterogeneous computing system, an inference task associated with a machine learning (ML) model;
scheduling a first set of calculations to be made at a first type of processor of the heterogeneous computing system based on compute resources for the execution of the inference task on the first type of processor that are determined at runtime;
scheduling a second set of calculations to be made at a second type of processor of the heterogeneous computing system, based on compute resources for the execution of the inference task on the second type of processor that are determined at runtime; and
combining the first set of calculations made on the first type of processor with the second set of calculations made on the second type of processor.

2. The method of claim 1, wherein the first type of processor is a neural processing unit, and wherein the second type of processor is a central processing unit.

3. The method of claim 1 further comprising before receiving the inference task associated with the ML model:
receiving a plurality of inference tasks performed using the ML model;
determining, for each of the plurality of inference tasks, a ratio of calculations performed on the first type of processor relative to the second type of processor when executing the respective inference task; and
saving, at the computing system, the ratios for the plurality of inference tasks.

4. The method of claim 3 further comprising:
receiving, at the heterogeneous computing system, one of the plurality of inference tasks to be performed using the ML model, wherein scheduling the first and second sets of calculations is based on the saved ratio for the received inference task.

5. The method of claim 1, wherein the first set of calculations and the second set of calculations are associated with different layers of the ML model.

6. The method of claim 1, wherein the first set of calculations and the second set of calculations are associated with different tensors from a same layer of the ML model.

7. The method of claim 1, wherein the first set of calculations and the second set of calculations are associated with different sub-tensors from a same tensor of the same layer of the ML model.

8. The method of claim 1 further comprising:
determining a battery state of the heterogeneous computing system;
determining a power usage of the first processor in relation to the battery state; and determining the power usage of the second processor in relation to the battery state,
wherein scheduling the first and second sets of calculations is performed based on the power usage of the first and second processors.

9. The method of claim 1 further comprising:
determining a current memory usage of the heterogeneous computing system,
wherein scheduling the first and second sets of calculations is performed based on the current memory usage of the first and second processors.

10. A system executable by one or more computer processors to perform operations, the operations comprising:
receiving, at a heterogeneous computing system, an inference task associated with an ML model;
scheduling a first set of calculations to be made at a first type of processor of the heterogeneous computing system based on compute resources for the execution of the inference task on the first type of processor that are determined at runtime;
scheduling a second set of calculations to be made at a second type of processor of the heterogeneous computing system based on the compute resources for the execution of the inference task on the second type of processor that are determined at runtime; and
combining the first set of calculations made on the first type of processor with the second set of calculations made on the second type of processor.

11. The system of claim 10 further comprising before receiving the inference task associated with the ML model:
receiving a plurality of inference tasks performed using the ML model;
determining, for each of the plurality of inference tasks, a ratio of calculations performed on the first type of processor relative to the second type of processor when executing the respective inference task; and
saving, at the computing system, the ratios for the plurality of inference tasks.

12. The system of claim 11 further comprising:
receiving, at the heterogeneous computing system, one of the plurality of inference tasks to be performed using the ML model, wherein scheduling the first and second sets of calculations is based on the saved ratio for the received inference task.

13. The system of claim 10, wherein the first set of calculations and the second set of calculations are associated with different layers of the ML model.

14. The system of claim 10, wherein the first set of calculations and the second set of calculations are associated with different tensors from a same layer of the ML model.

15. The system of claim 10, wherein the first set of calculations and the second set of calculations are associated with different sub-tensors from a same tensor of a same layer of the ML model.

16. The system of claim 10 further comprising:
determining a battery state of the heterogeneous computing system;
determining a power usage of the first processor in relation to the battery state; and determining the power usage of the second processor in relation to the battery state
wherein scheduling the first and second sets of calculations is performed based on the power usage of the first and second processors.

17. The system of claim 10 further comprising:
determining a current memory usage of the heterogeneous computing system,
wherein scheduling the first and second sets of calculations is performed based on the current memory usage of the first and second processors.

18. A computer-readable storage medium having computer-readable program code embodied therewith, the computer-readable program code executable by one or more computer processors to perform operations, the operations comprising:
receiving, at a heterogeneous computing system, an inference task associated with an ML model;
scheduling a first set of calculations to be made at a first type of processor of the heterogeneous computing system, based on compute resources for the execution of the inference task on the first type of processor that are determined at runtime;
scheduling a second set of calculations to be made at a second type of processor of the heterogeneous computing system, based on the compute resources for the execution of the inference task on the second type of processor that are determined at runtime; and
combining the first set of calculations made on the first type of processor with the second set of calculations made on the second type of processor.

19. The computer-readable program code of claim 18 further comprising before receiving the inference task associated with the ML model:
receiving a plurality of inference tasks performed using the ML model;
determining, for each of the plurality of inference tasks, a ratio of calculations performed on the first type of processor relative to the second type of processor when executing the respective inference task; and
saving, at the computing system, the ratios for the plurality of inference tasks.

20. The computer-readable program code of claim 19 further comprising:
receiving, at the heterogeneous computing system, one of the plurality of inference tasks to be performed using the ML model, wherein scheduling the first and second sets of calculations is based on the saved ratio for the received inference task.
